(19) United States
(12) Patent Application Publication
(10) Pub. No.: US 2025/0343429 A1
(43) Pub. Date: Nov. 6, 2025

(54) ADAPTION POWER SETTING AND PROTECTION METHOD IN POWER TRANSMISSION AND POWER SUPPLY SYSTEM USING THE SAME

(71) Applicant: NUVOTON TECHNOLOGY CORPORATION, HSINCHU CITY (TW)

(72) Inventor: CHENG-CHIH WANG, Zhubei City (TW)

(21) Appl. No.: 18/926,679

(22) Filed: Oct. 25, 2024

(30) Foreign Application Priority Data
May 6, 2024 (TW) 113116642

(51) Int. Cl. H02J 7/00

(52) U.S. Cl. CPC H02J 7/00712; H02J 7/00032; H02J 7/00304

(57) ABSTRACT

The preferred embodiment of the present disclosure relates to an adaptive power setting and protection method in power transmission and a power supply system using the same. The method includes: providing a power and signal transmission line between a power source and a power sink; providing a corresponding output voltage according to a power request transmitted by the power sink from the power and signal transmission line; detecting an output current by the power source; receiving a feedback voltage from the power sink through the power and signal transmission line; limiting the output current when a ratio of the output current to the feedback voltage exceeds a specification; and increasing the output voltage to perform voltage compensation according to the feedback voltage when the ratio of the output current to the feedback voltage does not exceed the specification.

### CROSS-REFERENCE TO RELATED APPLICATION

This application claims the priority from the TW Patent Application No. 113116642, filed on May 6, 2024, and all contents of such TW Patent Application are comprised in the present disclosure.

### BACKGROUND

### 1. Field of the Invention

The present invention is related to power supply technologies, and in particular to an adaptive power setting and protection method in power transmission and a power supply system using the same.

### 2. Description of the Related Art

FIG. 1 is a schematic circuit block diagram of a conventional Universal Serial Bus Type-C(TYPE-C) charging system. Please refer to FIG. 1, the USB Type-C charging system includes a power source 101, a power sink 102, and a power and signal transmission line 103. The power source 101 transmits power to the power sink 102 through a bus power line VBUS of the power and signal transmission line 103. The power sink 102 and the power source 101 communicate, according to the predefined protocol, through a channel configuration signal line CC to ensure fast and efficient power transmission.

Furthermore, typical USB Type-C charging protocols, such as Universal Serial Bus Power Delivery (USB PD), enable the charger and the sink to negotiate appropriate charging voltage and current, thereby enhancing charging efficiency and safety. The messages fed back by the power sink 102 through the channel configuration signal line CC include battery voltage, battery current, and battery temperature, etc. in addition, the Programmable Power Supply (PPS) standard, a protocol developed by Qualcomm, enables the charger to provide more precise charging voltage and current according to the actual needs of the sink, thereby further enhancing charging efficiency and safety. In this protocol, the power sink 102 feeds back, through the channel configuration signal line CC, battery voltage, battery current, battery temperature, battery health status, and battery manufacturing information, etc.

However, in the aforementioned USB Type-C charging system, the power and signal transmission line 103 used by the user generally has a certain impedance, which may cause a difference in the voltage levels at both terminals of the bus power line VBUS (i.e., the power source 101 and the power sink 102). The difference is particularly obvious during high power and large current transmission.

### SUMMARY

Embodiments of the present disclosure provide an adaptive power setting and protection method in power transmission and a power supply system using the same to mitigate voltage difference caused by the impedance at both terminals of a bus power line of a power and signal transmission line.

Other embodiments of the present disclosure provides an adaptive power setting and protection method in power transmission and a power supply system using the same to obtain the impedance at both terminals of a bus power line of a power and signal transmission line, thereby preventing burnout caused by excessive current.

Embodiments of the present disclosure provides an adaptive power setting and protection method in power transmission, wherein the adaptive power setting and protection method is adapted to a power source, the power source and a power sink are connected through a power and signal transmission line, and the adaptive power setting and protection method includes: providing, by the power source, an output voltage and an output current according to a power request transmitted by the power sink through the power and signal transmission line; receiving, by the power source, a feedback voltage from the power sink through the power and signal transmission line; limiting, by power source, the output current when a ratio of the output current to the feedback voltage exceeds a specification; and adjusting, by power source, the output voltage according to the feedback voltage when the ratio of the output current to the feedback voltage does not exceed the specification.

Embodiments of the present disclosure provides a power supply system, including: a power and signal transmission line, a power sink, and a power source. The power sink is coupled to one terminal of the power and signal transmission line and configured to transmit a power request through the power and signal transmission line. The power sink feeds back a feedback voltage through the power and signal transmission line. The power source is coupled to the other terminal of the power and signal transmission line and configured to determine an output voltage according to the received power request, wherein the power source detects an output current. When a ratio of the output current to the feedback voltage exceeds a specification, the power source limits the output current. When the ratio of the output current to the feedback voltage does not exceed the specification, the power source increases the output voltage based on the feedback voltage to perform voltage compensation for the feedback voltage.

According to the adaptive power setting and protection method in power transmission and a power supply system using the same provided by a preferred embodiment of the present disclosure, the power and signal transmission line includes a channel configuration signal (CC) line, wherein the power sink feeds back a feedback voltage from the channel configuration signal line. In a preferred embodiment, the power source calculates an impedance of the power and signal transmission line according to the output current and the feedback voltage fed back from the power sink. In a preferred embodiment, the power source determines that the impedance exceeds the specification and limits the output current. The power source determines that the impedance does not exceed the specification and increases the output voltage to perform voltage compensation according to a difference between the feedback voltage and the output voltage.

According to the adaptive power setting and protection method in power transmission and a power supply system using the same provided by a preferred embodiment of the present disclosure, the power sink transmits the power request through a Universal Fast Charging Specification (UFCS) protocol, wherein the power sink feeds back the feedback voltage from the power and signal transmission line through a Universal Asynchronous Receiver/Transmitter (UART) protocol.

Based on the above, embodiments of the present disclosure disclose that the power sink feeds back, by using a manner of data transmission, the feedback voltage through the power and signal transmission line. Thus, the power source may immediately know the impedance of the power and signal transmission line. If the impedance exceeds a safety specification, the current can be immediately limited to prevent burning of the power and signal transmission line. Furthermore, even if the impedance of the power supply and signal transmission line meets the specification, voltage compensation can be performed at the power source according to the feedback voltage, so that the power sink may receive the complete requested power.

To further understand the technology, means, and effects of the present disclosure, reference may be made by the detailed description and drawing as follows. In this way, the purposes, features and concepts of the present disclosure can be thoroughly and concretely understood. However, the following detail description and drawings are only used to reference and illustrate the implementation of the present disclosure, and they are not used to limit the present disclosure.

### BRIEF DESCRIPTION OF THE DRAWINGS

The drawings are provided to make the persons with ordinary knowledge in the field of the art further understand the present disclosure, and are incorporated into and constitute a part of the specification of the present disclosure. The drawings illustrate demonstrated embodiments of the present disclosure, and are used to explain the principal of the present disclosure together with the description of the present disclosure.

FIG. 1 is a schematic circuit block diagram of a conventional Universal Serial Bus Type-C(TYPE-C) charging system.

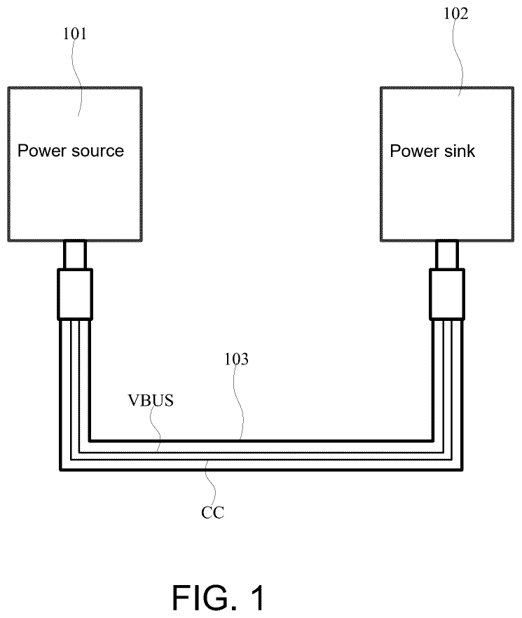

FIG. 2 is a schematic system block diagram of a power supply system according to a preferred embodiment of the present disclosure.

FIG. 3 is a schematic flowchart diagram of an adaptive power setting and protection method in power transmission according to a preferred embodiment of the present disclosure.

The embodiments of the present disclosure are described in detail as reference, and the drawings of the present disclosure are illustrated. In the case of possibility, the element symbols are used in the drawings to refer to the same or similar components. In addition, the embodiment is only one approach of the implementation of the design concept of the present disclosure, and the following multiple embodiments are not intended to limit the present disclosure.

### DESCRIPTION OF THE PREFERRED EMBODIMENTS

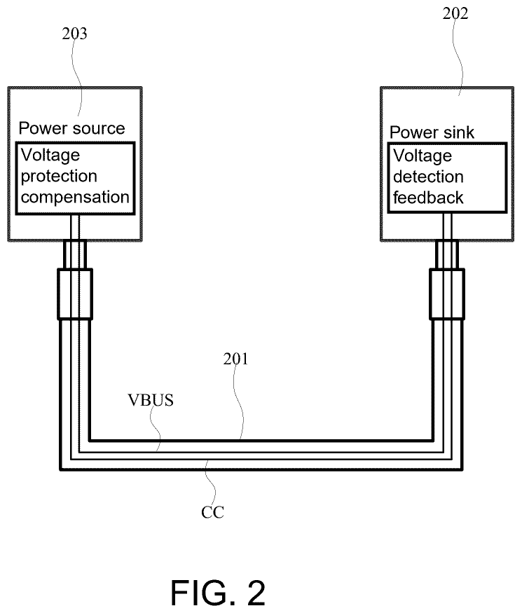

FIG. 2 is a schematic system block diagram of a power supply system according to a preferred embodiment of the present disclosure. Please refer to FIG. 2, the power supply system includes a power and signal transmission line 201, a power sink (or power reception terminal) 202 and a power source (or power supply terminal). The power and signal transmission line 201 in this embodiment uses a Universal Serial bus Type C (TYPE-C) transmission line as an example.

In this embodiment, when the power source 203 intends to charge the power sink 202, the power source 203 and the power sink 202 may first be coupled to the two terminals of the power and signal transmission line 201, respectively. Then, the power sink 202 transmits a power request/requirement to the power source 203 through a channel configuration signal line CC of the power and signal transmission line 201. After the power source 203 receives the power request through the channel configuration signal line CC of the power and signal transmission line 201, the VBUS terminal of the bus power line may output the output voltage according to the power request and the supported fast charging protocol specifications.

However, the resistance of the bus power line VBUS or the ground line GND of the power and signal transmission line 201 is not zero. Generally speaking, to ensure that the sink can obtain sufficient voltage and current, the Universal Serial Bus (USB) standard specifies that the resistance of the bus power line VBUS should be less than 100 mΩ (0.1Ω). In general, the resistance of the bus power line VBUS of the USB is between 10 mΩ and 50 mΩ. However, the power and signal transmission line 201, when used by the user for a long time, may cause the resistance of the bus power line VBUS to become too high due to bending, other usage factors, or because the power and signal transmission line 201 purchased by the user does not meet the specification.

In the aforementioned situation, assume that the resistance is 0.5Ω. Under the typical charging rate, with an output voltage of 5V and a current of 0.5 A, the power sink 202 receives, from the bus power line VBUS, a voltage of 4.75V and a current of 0.5 A, resulting in a power of 2.75 W. This voltage still falls within the USB standard specifications, so it does not cause too many issues. However, when the power sink 202 requires fast charging, such as 30 W with an output voltage of 15V and a current of 2 A, the voltage received by the power sink 202 from the bus power line VBUS is only 14V, which exceeds the USB standard specification. In addition, since the impedance of the cable and the connector contacts is 0.5n, the power consumption of the power and signal transmission line 201 is 1 W. This situation may cause the power and signal transmission line 201 to burn out.

Thus, in this embodiment, the power sink 202 and the power source 203 are designed with new transmission commands and feedback mechanisms. The power sink 202 feeds back, by using the channel configuration signal line CC, the feedback voltage received from the bus power line VBUS to the power source 203 through the power and signal transmission line 201. The power source 203 decodes that the feedback voltage is 14V from the channel configuration signal line CC and detects that an output current is 2 A from the feedback mechanism of its own circuit. Accordingly, the power source 203 may estimate the impedance of the power and signal transmission line 201 through the output current and the feedback voltage.

After the power source 203 finds the impedance of the power and signal transmission line 201 with the output current as well as the voltage difference between the feedback voltage and the output voltage, it may then determine whether maintaining a 2 A current, for example as described above, is feasible. In this embodiment, an impedance upper limit value, such as 0.25Ω, is set. Since the power source 203 estimates that the impedance is 0.5Ω, which exceeds the specification in this embodiment, the power source 203 activates limitation on the output current to prevent the power and signal transmission line 201 from burning out. In this embodiment, since the resistance exceeds the reasonable impedance range, there is a high possibility that the power and signal transmission line 201 is damaged. In the preferred embodiment, in addition to lowering the voltage level of the bus power line VBUS and the overcurrent protection level to an absolutely safe level, a warning signal is also generated to notify the user to check the reliability of the power and signal transmission line 201.

Assume that the impedance of the power and signal transmission line 201 is 0.25Ω, when the power sink 202 likewise requires fast charging, such as 30 W with 15V and 2 A described above, the power sink 202 receives the feedback voltage of 14.5V and feeds back to the power source 203 through the power and signal transmission line 201 by using the channel configuration signal line CC. The power source 203 receives data of the received voltage of 14.5V and accordingly determines the impedance value as 0.25Ω. Since the impedance value of 0.25Ω does not exceed the specification, the power source 203 increases the output voltage to 15.5V, which enables the power sink 202 to receive a voltage of 15V, thereby compensating for the voltage difference caused by the impedance value of 0.25Ω. In this way, a complete 30 W may be delivered to the power sink 202.

Although the aforementioned embodiment uses impedance calculation as an example, those skilled in the art should understand that a ratio of voltage to current may also be used as an embodiment. Specifically, conductance, the reciprocal of resistance, may serve as a determination mechanism, and the present disclosure is not limited herein. In addition, although the aforementioned embodiment uses the USB Type-C transmission line specification for fast charging, such as Power Delivery (PD) specification or Programmable Power Supply (PPS) specification, those skilled in the art should understand that, in addition to the above specifications, the present disclosure may also use a Universal Fast Charging Specification (UFCS). The difference is that the above embodiment uses the channel configuration signal line for modulation and transmission, while the UFCS performs transmission through a Universal Asynchronous Receiver/Transmitter (UART) interface by using the USB data positive terminal D+ and data negative terminal D−. In addition, the UFCS may perform data transmission through an Inter-Integrated Circuit (I2C) interface by using the channel configuration signal lines CC1 and CC2. Since the I2C interface and UART interface do not require additional hardware circuit support or additional software protocols, interface costs and complexity may be reduced. Thus, the present disclosure is not limited herein.

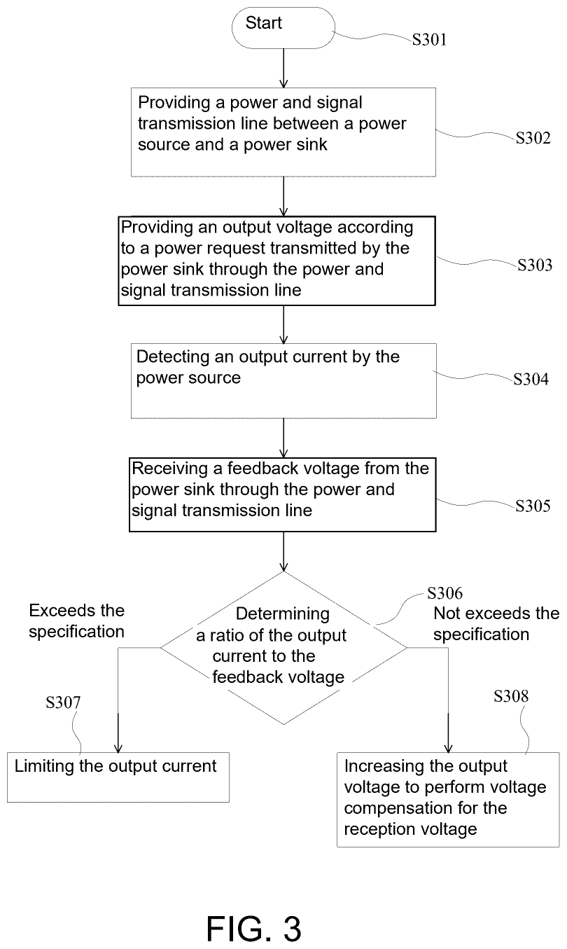

The aforementioned embodiments may be summarized into an adaptive power setting and protection method in power transmission. FIG. 3 is a schematic flowchart diagram of an adaptive power setting and protection method in power transmission according to a preferred embodiment of the present disclosure. Please refer to FIG. 3, the adaptive power setting and protection method in power transmission includes the following steps:

Step S301: Start.

Step S302: Providing a power and signal transmission line between a power source and a power sink.

Step S303: Providing an output voltage according to a power request transmitted by the power sink through the power and signal transmission line.

Step S304: Providing and detecting an output current by the power source.

Step S305: Receiving a feedback voltage from the power sink through the power and signal transmission line. As described in the above embodiments, the power sink must have the capability of detecting the feedback voltage as well as feeding back, for example from the channel configuration signal line CC, the feedback voltage to the power sink. The power sink must have the capability of decoding the feedback voltage transmitted from the channel configuration signal line CC.

Step S306: Determining a ratio of the output current to the feedback voltage. As described in the above embodiments, by using the aforementioned output current and the feedback voltage, the resistance value of the bus power line VBUS of the power and signal transmission line may be estimated. This allows for determining whether the power and signal transmission line meets the specification. If it exceeds the specification, step S307 is performed. If it meets the specification, step S308 is performed.

Step S307: Limiting the output current. As described above, when the resistance value of the bus power line VBUS exceeds the specification, such as 0.5Ω, the resistance value may cause burning out of the power and signal transmission line in the case of high-power transmission. Thus, the power source limits the output current. In addition, if the resistance has already exceeded the range of reasonable impedance, the voltage level of the bus power line VBUS and the overcurrent protection level may be lowered to an absolutely safe level. At the same time, a warning signal is generated to notify the user to check the reliability of the power and signal transmission line 201.

Step S308: Increasing the output voltage to perform voltage compensation for the feedback voltage according to the feedback voltage. For example, when the resistance value of the bus power line VBUS is just within the specification, such as 0.25Ω, the feedback voltage is 14.5V at this moment. Thus, the output voltage is increased by 0.5V to 15.5V, and the feedback voltage received by the power sink will meet the power requested by the power sink.

To sum up, embodiments of the present disclosure disclose that the power sink feeds back, by using a manner of data transmission, the feedback voltage through the power and signal transmission line. Thus, the power source may immediately know the impedance of the power and signal transmission line. If the impedance exceeds a safety specification, the current can be immediately limited to prevent burning of the power and signal transmission line. Furthermore, even if the impedance of the power supply and signal transmission line meets the specification, voltage compensation can be performed at the power source according to the feedback voltage, so that the power sink may receive the complete requested power.

It should be understood that the examples and the embodiments described herein are for illustrative purpose only, and various modifications or changes in view of them will be suggested to those skilled in the art, and will be comprised in the spirit and scope of the application and the appendix with the scope of the claims.

What is claimed is:

1. An adaptive power setting and protection method in power transmission, wherein the adaptive power setting and protection method is adapted to a power source, the power source and a power sink are connected through a power and signal transmission line, and the adaptive power setting and protection method comprises:
providing, by the power source, an output voltage and an output current based on a power request transmitted by the power sink through the power and signal transmission line;
receiving, by the power source, a feedback voltage from the power sink through the power and signal transmission line;
limiting, by power source, the output current when a ratio of the output current to the feedback voltage exceeds a specification; and
adjusting, by power source, the output voltage based on the feedback voltage when the ratio of the output current to the feedback voltage does not exceed the specification.

2. The adaptive power setting and protection method according to the claim 1, wherein the feedback voltage from the power sink through the power and signal transmission line is obtained through a channel configuration signal line.

3. The adaptive power setting and protection method according to the claim 1, further comprising:
calculating an impedance of the power and signal transmission line based on the output current and the feedback voltage.

4. The adaptive power setting and protection method according to the claim 3, wherein the step of limiting the output current when the ratio of the output current to the feedback voltage exceeds the specification comprises:
limiting the output current when the impedance exceeds the specification;
wherein the step of increasing the output voltage based on the feedback voltage when the ratio of the output current to the feedback voltage does not exceed the specification comprises:
increasing the output voltage based on the feedback voltage to perform voltage compensation when the impedance does not exceed the specification.

5. The adaptive power setting and protection method according to the claim 1, wherein providing the output voltage based on the power request transmitted by the power sink from the power and signal transmission line is implemented by using a Universal Fast Charging Specification (UFCS) protocol;
wherein the feedback voltage from the power sink is obtained through a Universal Asynchronous Receiver/Transmitter (UART) protocol.

6. A power supply system, comprising:
a power and signal transmission line;
a power sink, coupled to one terminal of the power and signal transmission line, configured to transmit a power request through the power and signal transmission line;
a power source, coupled to the other terminal of the power and signal transmission line, configured to determine an output voltage based on the received power request, wherein the power source detects an output current;
wherein the power sink transmits a feedback voltage through the power and signal transmission line, and when a ratio of the output current to the feedback voltage exceeds a specification, the power source limits the output current, wherein when the ratio of the output current to the feedback voltage does not exceed the specification, the power source increases the output voltage based on the feedback voltage to perform voltage compensation for the feedback voltage.

7. The power supply system according to the claim 6, wherein the power and signal transmission line comprises a channel configuration signal line, wherein the power sink transmits the feedback voltage from the channel configuration signal line.

8. The power supply system according to the claim 6, wherein the power source calculates an impedance of the power and signal transmission line based on the output current and the feedback voltage.

9. The power supply system according to the claim 8, wherein when the power source determines that the impedance exceeds the specification, the power source limits the output current;
wherein when the power source determines that the impedance does not exceed the specification, the power source increases the output voltage to perform voltage compensation based on a difference between the feedback voltage and the output voltage.

10. The power supply system according to the claim 6, wherein the power sink transmits the power request through a Universal Fast Charging Specification (UFCS) protocol, and transmits the feedback voltage through a Universal Asynchronous Receiver/Transmitter (UART) protocol.
